(19) United States
(12) Patent Application Publication
(10) Pub. No.: US 2024/0255764 A1
(43) Pub. Date: Aug. 1, 2024

(54) HEAD-MOUNTED DISPLAY

(71) Applicant: Sony Interactive Entertainment Inc., Tokyo (JP)

(72) Inventors: Manabu Ishioka, Tokyo (JP); Toshikazu Arai, Chiba (JP)

(73) Assignee: Sony Interactive Entertainment Inc., Tokyo (JP)

(21) Appl. No.: 18/560,989

(22) PCT Filed: May 25, 2022
(86) PCT No.: PCT/JP2022/021373

§ 371 Date: Nov. 15, 2023

(30) Foreign Application Priority Data
Jun. 4, 2021 (JP) 2021-094604

(51) Int. Cl. G02B 27/01

(52) U.S. Cl. CPC G02B 27/0176; G02B 2027/015; G02B 2027/0154

(57) ABSTRACT

Provided is a head-mounted display which can use a spring for adjusting the size of a mounting band to the head of a user while suppressing increase of the size of an adjustment mechanism in a forward and rearward direction. The adjustment mechanism includes an operation dial operated by a user and a link member held in engagement with a rear portion (rack) of a right band portion and a rear portion (rack) of a left band portion, and moves the link member in such a manner that the length of the mounting band changes in response to a movement of the operation dial. The adjustment mechanism includes a spiral spring that applies elastic force to the link member. The spiral spring is arranged in such a manner as to have its center line extending along the forward and rearward direction as viewed in top plan.

### TECHNICAL FIELD

The present invention relates to a head-mounted display.

### BACKGROUND ART

In recent years, usage of a head-mounted display has been and is progressing. (The head-mounted display is hereinafter referred to as an HMD.) The HMD includes a main body that has a display unit to be positioned in front of the eyes of a user, and a mounting band that is mounted on the head of the user and supports the main body thereon. In the HMD disclosed in U.S. Patent Application Publication No. 2018/027676, the mounting band includes, at a rear portion thereof, a movable portion that can be moved in a forward and rearward direction. By moving the movable portion in the forward and rearward direction, the size of the mounting band can be adjusted according to the size of the head of the user.

### SUMMARY

### Technical Problem

The HMD disclosed in U.S. Patent Application Publication No. 2018/027676 includes a rubber band that applies elastic force to the movable portion in a direction of reducing the size of the mounting band, and an operation dial. With the rubber band, the mounting band can temporarily be fixed to the head of the user. After temporarily fixing the head-mounted display to the own head, the user can reduce the size of the mounting band by rotating the operation dial, to thereby make the mounting band fit the head of the user.

### Solution to Problem

An example of a head-mounted display proposed in the present disclosure includes a main body including a display unit, and a mounting band that supports the main body. The mounting band includes a right band portion that is a right portion of the mounting band and a left band portion that is a left portion of the mounting band. Further, the mounting band includes an adjustment mechanism that includes an operation member operated by a user and a link member held in engagement with a rear portion of the right band portion and a rear portion of the left band portion, the adjustment mechanism moving the link member in such a manner that the length of the mounting band changes in response to a movement of the operation member. The adjustment mechanism includes a spiral spring that apples elastic force to the link member. The spiral spring is arranged in such a manner as to have its center line extending along a forward and rearward direction as viewed in top plan. With this head-mounted display, the spring for adjusting the size of the mounting band to the head of the user can be used while increase of the size of the adjustment mechanism in the forward and rearward direction is suppressed.

Another example of the head-mounted display proposed in the present disclosure includes a main body including a display unit, and a mounting band that supports the main body. The mounting band includes a right band portion that is a right portion of the mounting band and a left band portion that is a left portion of the mounting band. Further, the mounting band includes an adjustment mechanism that includes an operation member operated by a user and a link member held in engagement with a rear portion of the right band portion and a rear portion of the left band portion, the adjustment mechanism moving the link member in such a manner that the length of the mounting band changes in response to a movement of the operation member. The operation member is a rotatable member. The adjustment mechanism includes a ratchet mechanism that defines a rotation direction of the operation member to one direction and a clutch mechanism that performs switching between a state in which the link member is interlocked with the operation member and another state in which the link member is not interlocked with the operation member. Part of the ratchet mechanism and part of the clutch mechanism are used in a shared manner. With this head-mounted display, the number of parts can be reduced.

### BRIEF DESCRIPTION OF DRAWINGS

FIG. 1 is a perspective view depicting an example of a head-mounted display proposed in the present disclosure.

FIG. 2 is a side elevational view of the head-mounted display depicted in FIG. 1.

FIG. 3 is a rear elevational view of a movable portion provided at a rear portion of a mounting band.

FIG. 4 is a rear elevational view depicting part of a mechanism accommodated in the movable portion depicted in FIG. 3.

FIG. 5A is an exploded perspective view of the mechanism provided in the movable portion. In this figure, parts are viewed from a diagonally front side.

FIG. 5B is an exploded perspective view of the mechanism provided in the movable portion. In this figure, parts are viewed from a diagonally rear side.

FIG. 6A is a rear elevational view depicting the mechanism accommodated in the movable portion. In this figure, a holder, a ratchet mechanism, and a clutch mechanism are depicted. A clutch stopper is positioned at a clutch stopper cancelation position.

FIG. 6B is a cross sectional view taken along line VIb-VIb in FIG. 6A.

FIG. 6C is an enlarged view of an upper portion of FIG. 6B. In this figure, a clutch member is positioned at a lock position, and the clutch stopper is positioned at the clutch stopper cancelation position.

FIG. 7 is a cross sectional view taken at a position similar to that in FIG. 6C. Depicted here is a state in which an operation button depicted in FIG. 6C is pushed.

FIG. 8A is a rear elevational view depicting the mechanism accommodated in the movable portion, as in FIG. 6A. In this figure, the clutch stopper is positioned at a clutch stopper working position.

FIG. 8B is a cross sectional view taken at a position similar to that in FIG. 6C. In this figure, the clutch member is positioned at an unlock position, and the clutch stopper is positioned at the clutch stopper working position.

### DESCRIPTION OF EMBODIMENT

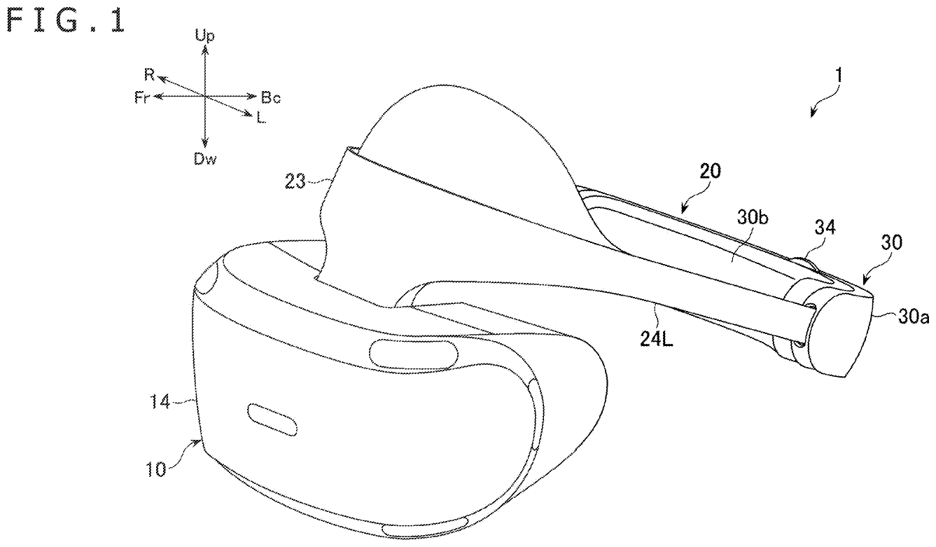

In the following, a head-mounted display (HMD) proposed in the present disclosure is described. In the present specification, as an example of the HMD, an HMD 1 depicted in FIG. 1 and so forth is described. In the following description, reference signs Fr and Bc indicated in FIG. 1 denote a forward direction and a rearward direction, respectively; reference signs R and L denote a rightward direction and a leftward direction, respectively; and reference signs Up and Dw denote an upward direction and a downward direction, respectively.

### Main Body

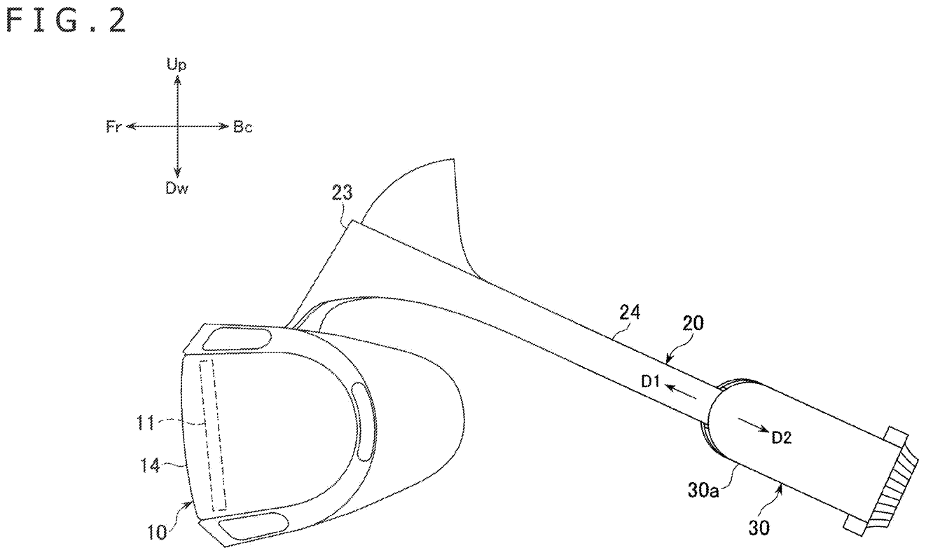

The HMD 1 includes a main body 10 at a front portion thereof. The main body 10 includes a housing 14 and a display unit 11 (refer to FIG. 2). The display unit 11 is accommodated in the housing 14. The display unit 11 displays a three-dimensional image thereon or displays a two-dimensional image thereon. As the display unit 11, for example, a liquid crystal display device or an organic electroluminescence (EL) display device can be used. The type of the display unit 11 is not restricted to any of them.

### Mounting Band

As depicted in FIG. 1, the HMD 1 includes a mounting band 20 for mounting the HMD 1 on the head of a user. The mounting band 20 extends from the main body 10 toward the rear side. The mounting band 20 has an annular shape as viewed in top plan and surrounds the head of the user when the HMD 1 is in use. A rear portion of the mounting band 20 is to be hung on the rear side of the head. In the example depicted, the mounting band 20 is connected to an upper portion of the main body 10.

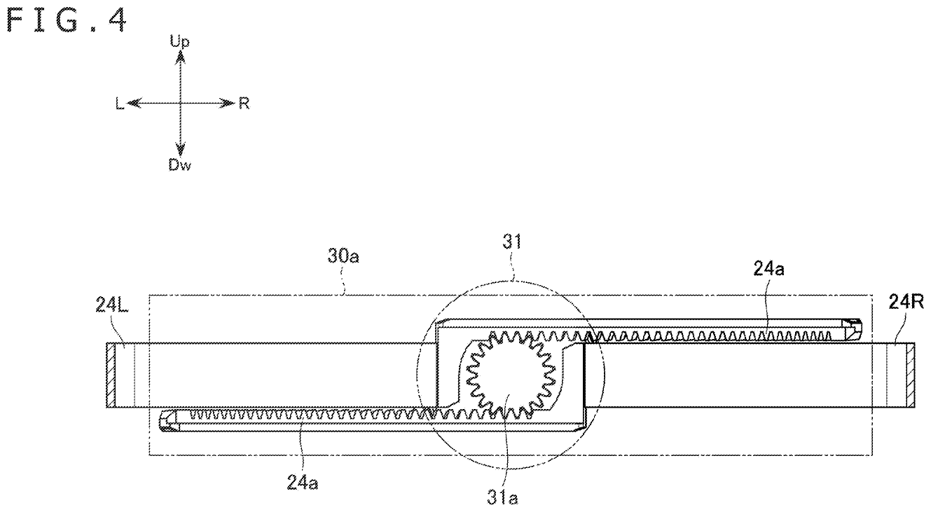

As depicted in FIG. 1, the mounting band 20 includes a right band portion 24R (refer to FIG. 4) extending toward the rear side and configuring a right portion of the mounting band 20 and a left band portion 24L extending toward the rear side and configuring a left portion of the mounting band 20. The mounting band 20 has a movable portion 30 at the rear portion thereof.

### Movable Portion

As depicted in FIG. 1, the mounting band 20 may have, on the front side thereof, a connection portion 23 connecting to the upper portion of the main body 10. The left and right band portions 24L and 24R may extend from a left portion and a right portion of the connection portion 23 toward the rear side, respectively. The structure of the mounting band 20 is not restricted to the example depicted. For example, the band portions 24L and 24R may extend from a left portion and a right portion of the main body 10 toward the rear side, respectively.

The movable portion 30 is positioned between rear portions of the left and right band portions 24L and 24R and configures the rear portion of the mounting band 20. The movable portion 30 includes a housing 30a. The rear portions of the left and right band portions 24L and 24R pass through respective openings formed at end portions of the housing 30a and are fitted in the housing 30a. Each of the left and right band portions 24L and 24R includes, at the rear portion thereof, a rack 24a (refer to FIG. 4) extending in a lengthwise direction of the mounting band 20. A pinion 31a (refer to FIG. 4) of a link member 31 hereinafter described is held in engagement with the rack 24a.

When the HMD 1 is in use, the mounting band 20 sandwiches the head of the user in the forward and rearward direction with the connection portion 23 and the movable portion 30 thereof. A cushion 30b (refer to FIG. 1) for coming into contact with the rear side of the head may be attached to the front side of the movable portion 30. Further, a cushion for coming into contact with the front side of the head may be attached to the rear side of the connection portion 23. The connection portion 23 and the band portions 24L and 24R may include a material having comparatively high rigidity such as, for example, plastics.

The movable portion 30 is movable relative to the band portions 24L and 24R in a direction in which the length of the mounting band 20 decreases and another direction in which the length of the mounting band 20 increases. By moving the movable portion 30, the user can adjust the length of the mounting band 20. In particular, when the movable portion 30 moves forward with respect to the band portions 24L and 24R, the length of the mounting band 20 decreases. Conversely, when the movable portion 30 moves rearward with respect to the band portions 24L and 24R, the length of the mounting band 20 increases. (In the following description, the direction in which the length of the mounting band 20 decreases is referred to as a “reduction direction,” and the direction in which the length of the mounting band 20 increases is referred to as an “expansion direction”). In FIG. 2, the expansion direction is denoted by reference sign D2, and the reduction direction is denoted by reference sign D1.

### Adjustment Mechanism

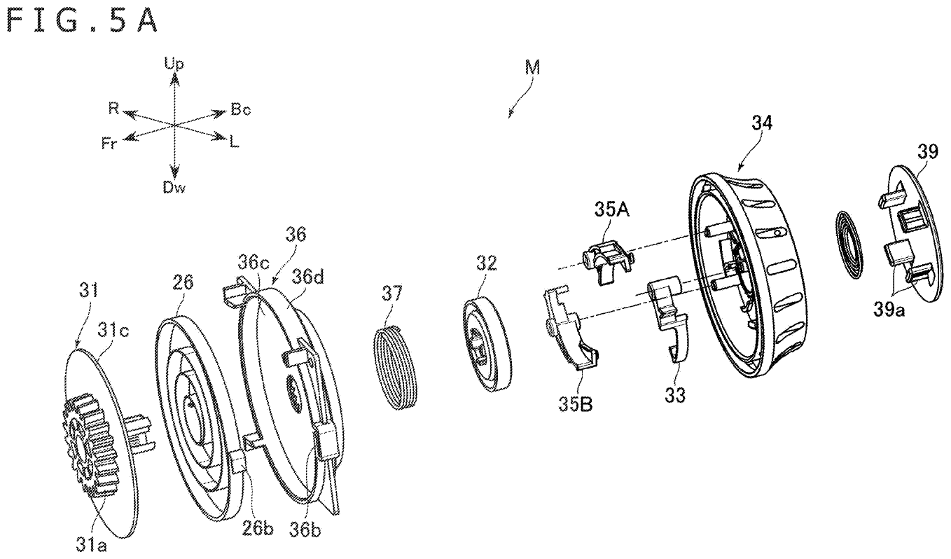

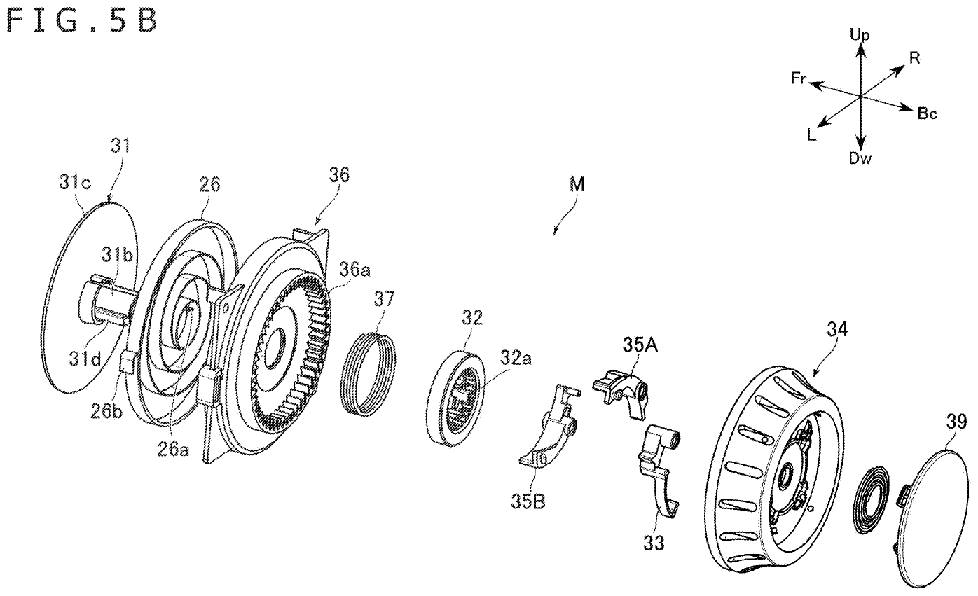

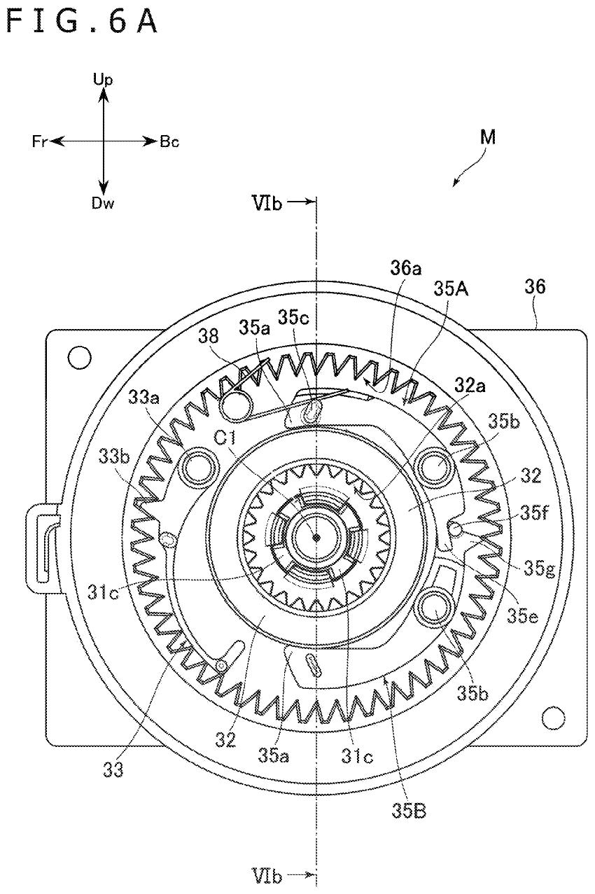

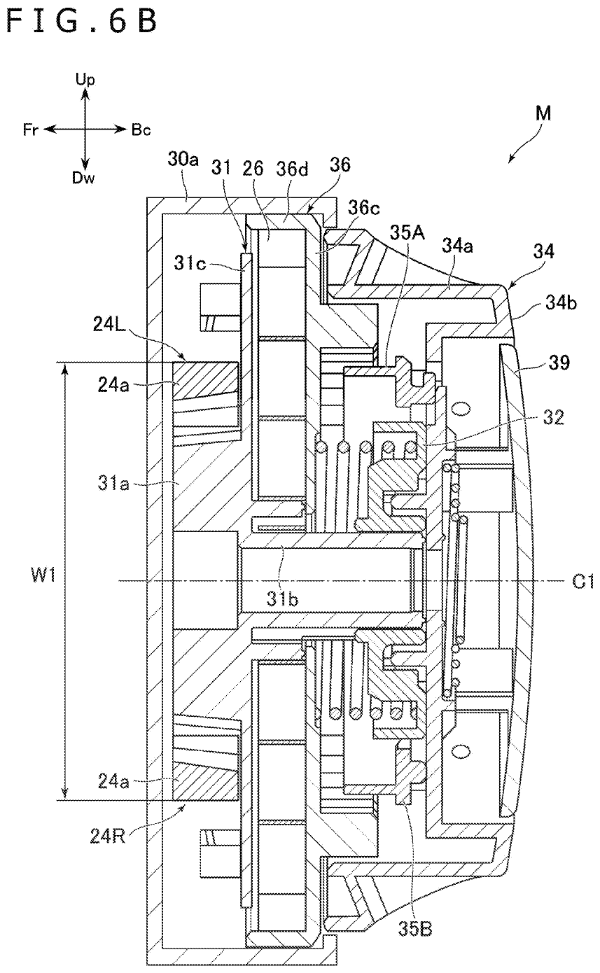

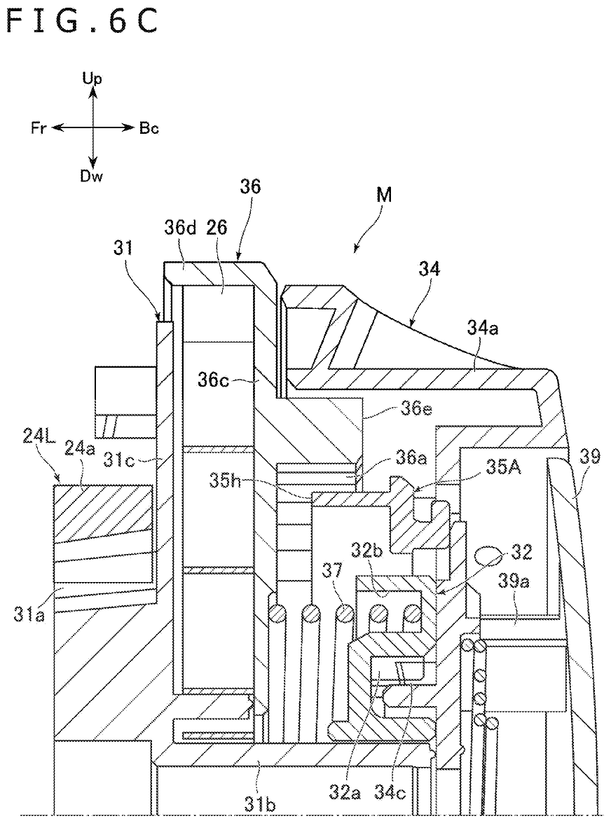

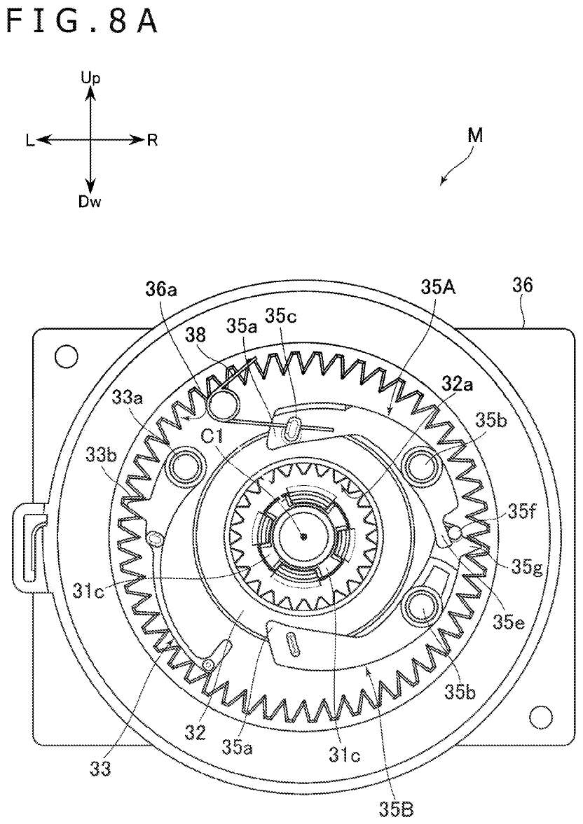

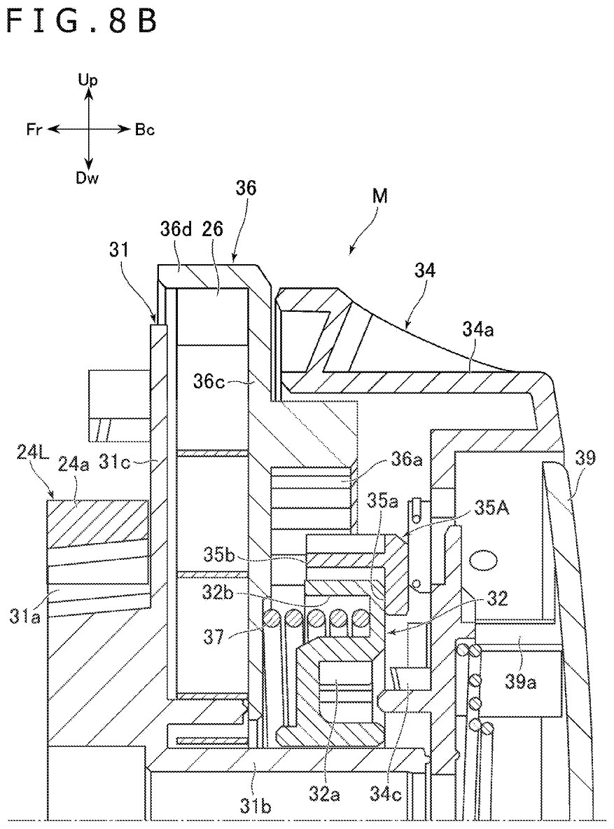

The movable portion 30 has built therein an adjustment mechanism M (refer to FIG. 5A) for adjusting the length of the mounting band 20. The adjustment mechanism M can switch the movable portion 30 between a lock state (FIGS. 6A and 6C) and an unlock state (FIGS. 8A and 8B). In the unlock state, movements of the movable portion 30 in the expansion direction and the reduction direction are permitted. In particular, in the unlock state, the movable portion 30 can be moved forward and rearward and increase and decrease of the length of the mounting band 20 are permitted. On the other hand, in the lock state, the movement of the movable portion 30 in the expansion direction is restricted. In particular, in the lock state, the rearward movement of the movable portion 30 is restricted, and increase of the length of the mounting band 20 is restricted. In an example described below, in the lock state, the movement of the movable portion 30 in the reduction direction is permitted. Unlike this example, in the lock state, the movement of the movable portion 30 in both the expansion direction and the reduction direction may be restricted.

As depicted in FIG. 5A, the adjustment mechanism M includes the link member 31, an operation dial 34 (operation member), a clutch member 32, a spiral spring 26, a holder 36, and an operation button 39.

### Link Member and Band Portion

As depicted in FIG. 4, the link member 31 (pinion 31a) is held in engagement with the racks 24a of the band portions 24L and 24R. In the lock state (FIG. 6C), the adjustment mechanism M connects the link member 31 and the operation dial 34 to each other through the clutch member 32. Then, rotation of the operation dial 34 is transmitted to the link member 31 such that the movable portion 30 is moved forward (length of the mounting band 20 is reduced) in response to a movement (rotation) of the operation dial 34.

As hereinafter described, the operation dial 34 is permitted to rotate only in one direction (rotation for moving the movable portion 30 forward). In the unlock state (FIG. 8C), the connection between the link member 31 and the operation dial 34 is canceled by the clutch member 32. Therefore, in this state, the forward movement and the rearward movement of the movable portion 30 are permitted.

As depicted in FIG. 4, the racks 24a of the left and right band portions 24L and 24R are spaced away from each other in the upward and downward direction. The link member 31 includes the pinion 31a (refer to FIG. 5A). The pinion 31a is arranged between and held in engagement with the racks 24a of the band portions 24L and 24R. Accordingly, the link member 31 is rotated together with the movement of the movable portion 30 in the forward and rearward direction.

The link member 31 may be supported, for example, by a support shaft (not depicted) formed on the housing 30a. In the example depicted, the link member 31 has a supporting portion 31b (refer to FIG. 6B). The supporting portion 31b is formed in a tubular shape. The support shaft (not depicted) is fitted with the supporting portion 31b such that the link member 31 is supported to be able to rotate around an axial line C1. The holder 36 is fixed on an inner side of the housing 30a. The supporting portion 31b of the link member 31 is fitted in a supporting hole formed at the center of the holder 36, in such a manner as to be able to rotate. The support structure for the link member 31 is not restricted to the example depicted. The link member 31 may be supported otherwise, for example, by the holder 36.

In the example depicted, the rack 24a of the right band portion 24R is positioned on the lower side of the pinion 31a, and the rack 24a of the left band portion 24L is positioned on the upper side of the pinion 31a (refer to FIG. 4). Accordingly, as viewed in rear elevation of the movable portion 30, the link member 31 rotates in a counterclockwise direction together with a movement of the movable portion 30 in the expansion direction (rearward direction). Conversely, the link member 31 rotates in a clockwise direction together with a movement of the movable portion 30 in the reduction direction (forward direction). The position of the rack 24a of the right band portion 24R and the position of the rack 24a of the left band portion 24L may be reverse to those in the example depicted. In this case, the rotation direction of the link member 31 is also reverse to that in the example depicted.

As depicted in FIG. 4, the pinion 31a is held in engagement with both of the racks 24a of the left and right band portions 24L and 24R. Therefore, the distance of a relative movement between the right band portion 24R and the movable portion 30 and the distance of a relative movement between the left band portion 24L and the movable portion 30 are equal to each other. As a result, the movable portion 30 moves parallelly in the forward and rearward direction. In the following description, the rotation direction of the link member 31 in a case where the movable portion 30 moves in the reduction direction is referred to as a “reduction rotation direction.” Further, the rotation direction of the link member 31 in a case where the movable portion 30 moves in the expansion direction is referred to as an “expansion rotation direction.”

### Spiral Spring

The spiral spring 26 (refer to FIG. 5A) applies elastic force to the link member 31. In the example depicted, the spiral spring 26 exerts elastic force in the reduction rotation direction (clockwise direction as viewed in rear elevation) to the link member 31. Accordingly, the movable portion 30 is biased in the reduction direction (forward) by the elastic force of the spiral spring 26.

With this structure, for example, when the user places the movable portion 30 into the unlock state, the movable portion 30 is moved forward by the elastic force of the spiral spring 26 and is brought into contact with the head of the user, whereupon the mounting band 20 is temporarily fixed to the head of the user. In the state in which the mounting band 20 is temporarily fixed to the head of the user, the user can perform position adjustment of the movable portion 30 (operation of the operation dial 34) to appropriate the length of the mounting band 20. The position adjustment of the movable portion 30 by the operation dial 34 is hereinafter described.

As depicted in FIG. 6, the spiral spring 26 is arranged such that the center line thereof extends along the forward and rearward direction as viewed in top plan of the HMD 1. In the example depicted, the center line of the spiral spring 26 is the same as the axial line C1 of the link member 31. With this arrangement of the spiral spring 26, the size of the spiral spring 26 can be secured sufficiently without increasing the size of the movable portion 30 in the forward and rearward direction.

The right band portion 24R and the left band portion 24L extend forward from the rear portions (racks 24a) thereof while being curved. As depicted in FIG. 6B, the spiral spring 26 is arranged on the rear side of the rear portion (rack 24a) of the right band portion 24R and the rear portion (rack 24a) of the left band portion 24L. With this arrangement of the spiral spring 26, the diameter of the spiral spring 26 can be increased without causing interference between the band portions 24L and 24R and the spiral spring 26. By using the spiral spring 26 having a greater diameter, in a process when the user pulls the movable portion 30 in the expansion direction (rearward), the change in force required to pull the movable portion 30 (in other words, elastic force of the spiral spring 26) can be reduced.

In the example depicted, the diameter of the spiral spring 26 is greater than the width W1 (refer to FIG. 6B) of the racks 24a of the band portions 24L and 24R in the upward and downward direction. Unlike the example depicted, the diameter of the spiral spring 26 may be substantially equal to the diameter of the operation dial 34. The diameter of the spiral spring 26 may otherwise be smaller than the diameter of the operation dial 34.

As depicted in FIG. 6B, the link member 31 has a wall portion 31c having a diameter greater than that of the pinion 31a. The holder 36 has a wall portion 36c facing the wall portion 31c in a direction along the axial line C1. The spiral spring 26 is arranged between the two wall portions 31c and 36c. The holder 36 may include an outer circumferential wall 36d (refer to FIG. 5A) that surrounds an outer circumferential face of the spiral spring 26. In the example depicted, the outer circumferential wall 36d has an annular shape. Also the diameter of an inner face of the outer circumferential wall 36d may be greater than the width W1 of the racks 24a of the band portions 24L and 24R in the upward and downward direction.

An end portion 26a (refer to FIG. 5B) on an inner side of the spiral spring 26 is fixed to the link member 31. In the example depicted, the end portion 26a has a hook shape and is fixed to an outer circumferential face of the supporting portion 31b of the link member 31. An end portion 26b (refer to FIG. 5A) on an outer side of the spiral spring 26 is fixed to the holder 36. In the example depicted, the end portion 26b has a hook shape and is held in engagement with an engaged portion 36b (refer to FIG. 5A) formed on the outer circumferential wall 36d of the holder 36.

The diameter of the supporting portion 31b to which the end portion 26a on the inner side of the spiral spring 26 is fixed is comparatively small. Therefore, the spring constant of the spiral spring 26 is low, and the force required to move the movable portion 30 in the expansion direction against the elastic force of the spiral spring 26 can be made small. In the example depicted, the diameter of the supporting portion 31b is smaller than the diameter of the pinion 31a (refer to FIG. 6B).

It is to be noted that, unlike the example depicted, the spiral spring 26 may not be fixed directly to the link member 31. For example, the end portion 26a on the inner side of the spiral spring 26 may be attached to a member different from the link member 31. Then, this member may be connected to the link member 31 in such a manner as to rotate integrally with the link member 31.

### Ratchet Mechanism

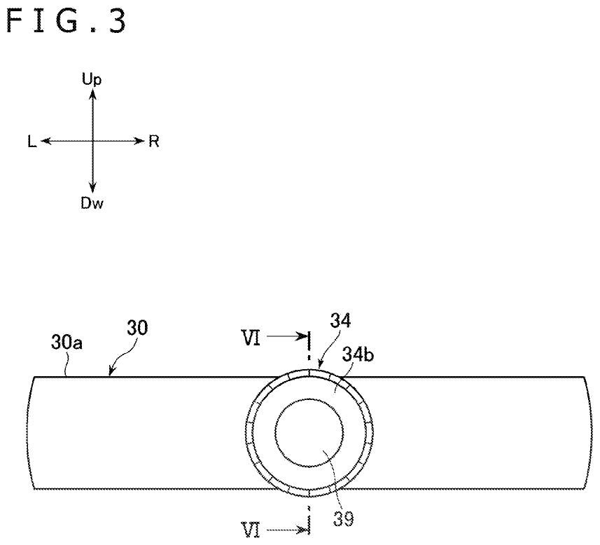

As depicted in FIG. 6B, the operation dial 34 may be arranged on the axial line C1 that is common to the link member 31. The operation dial 34 is rotatably supported. For example, the operation dial 34 is supported together with the link member 31 by a support shaft (not depicted) formed on the housing 30a of the movable portion 30. The operation dial 34 may be exposed to the rear side through an opening formed on a rear face of the housing 30a of the movable portion 30 (refer to FIG. 3).

The adjustment mechanism M includes a ratchet mechanism for the operation dial 34. The ratchet mechanism permits rotation of the operation dial 34 in the reduction rotation direction for moving the movable portion 30 forward and restricts rotation of the operation dial 34 in the expansion rotation direction for moving the movable portion 30 rearward.

As depicted in FIG. 6A, the ratchet mechanism may include, for example, a dial stopper 33 and a gear portion 36a formed on the holder 36. The dial stopper 33 is supported at a base portion thereof by the operation dial 34. For example, the dial stopper 33 has a supported portion 33a at the base portion thereof, and a support shaft formed on the operation dial 34 is fitted in a hole formed in the supported portion 33a. Consequently, the dial stopper 33 is permitted to move around the support shaft and rotates around the axial line C1 together with the operation dial 34. The dial stopper 33 has an engaging portion 33b. The dial stopper 33 is biased toward the gear portion 36a, for example, by an elastic portion (not depicted) in such a manner that the engaging portion 33b is engaged with the gear portion 36a. This elastic force may be exerted by a spring or may otherwise be elastic force of the dial stopper 33 itself that is exerted when the dial stopper 33 is engaged with the operation dial 34.

By the engagement between the gear portion 36a of the holder 36 and the engaging portion 33b of the dial stopper 33, the rotation direction of the operation dial 34 is restricted to the reduction rotation direction. In particular, the shape of teeth configuring the gear portion 36a and the shape of the engaging portion 33b are designed in such a manner as to permit rotation of the operation dial 34 in the reduction rotation direction (in the example depicted, in the clockwise direction) but restrict rotation of the operation dial 34 in the expansion rotation direction (in the example depicted, in the counterclockwise direction). The structure for restricting the rotation direction of the operation dial 34 is not necessarily limited to the example described above and may be changed suitably.

### Clutch Mechanism

The adjustment mechanism M includes a clutch mechanism. The clutch mechanism connects, in the lock state (FIGS. 6A and 6C), the link member 31 and the operation dial 34 to each other. On the other hand, in the unlock state (FIGS. (A and 8C), the clutch mechanism cancels the connection between the link member 31 and the operation dial 34. By the ratchet mechanism (dial stopper 33) described hereinabove, the operation dial 34 is permitted to rotate only in the reduction rotation direction. Therefore, the clutch mechanism connects, in the lock state, the link member 31 and the operation dial 34 to each other to permit the movement of the movable portion 30 in the reduction direction (forward direction) but restrict the movement of the movable portion 30 in the expansion direction (rearward direction). On the other hand, in the unlock state, the clutch mechanism permits the movement of the movable portion 30 in both the reduction direction and the expansion direction.

Further, the clutch mechanism connects the link member 31 and the operation dial 34 to each other such that they rotate integrally with each other together with a movement of the operation dial 34 in the reduction rotation direction. Accordingly, when the user rotates the operation dial 34 in the reduction rotation direction, the movable portion 30 moves in the reduction direction and, at the same time, the mounting band 20 transitions to the lock state, thereby restricting the movement of the movable portion 30 in the expansion direction. In other words, the length adjustment of the mounting band 20 (position adjustment of the movable portion 30) and the transition of the mounting band 20 to the lock state are implemented by one operation of the user.

The clutch mechanism includes the clutch member 32 (refer to FIG. 5A) for controlling the connection between the link member 31 and the operation dial 34, clutch stoppers 35A and 35B (refer to FIG. 5A) for controlling the movement of the clutch member 32, and the gear portion 36a of the holder 36 (refer to FIG. 5B).

### Clutch Member

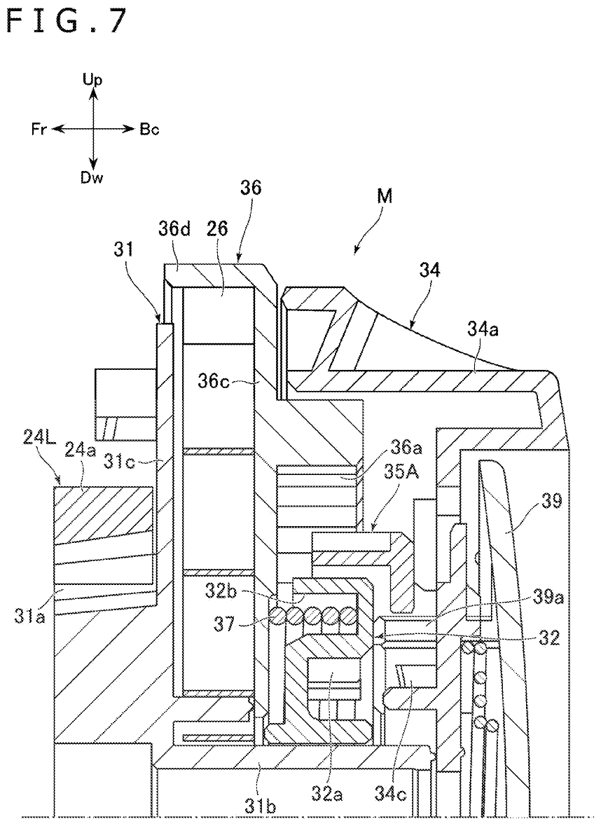

The clutch member 32 is movable between the lock position (refer to FIG. 6C) and the unlock position (refer to FIGS. 7 and 8B). As depicted in FIG. 6B, the clutch member 32 is arranged on the axial line C1 that is common to the link member 31 and the operation dial 34, and is rotatable around the axial line C1.

As depicted in FIG. 6B, the link member 31 has the supporting portion 31b extending in a direction along the axial line C1. The clutch member 32 has an annular shape and is fitted with an outer side of the supporting portion 31b. A protrusion 31d (refer to FIG. 6A) is formed on an outer circumferential face of the supporting portion 31b such that it extends in a direction along the axial line C1. A recessed portion for engaging with the protrusion 31d is formed on an inner circumferential face of the clutch member 32. Therefore, the clutch member 32 is movable relative to the link member 31 in a direction along the axial line C1 while engaging with the outer circumferential face of the supporting portion 31b such that it rotates together with the link member 31.

As depicted in FIGS. 6A and 6C, the clutch member 32 has an internal gear portion 32a that surrounds the supporting portion 31b. The operation dial 34 has an engaging portion 34c (refer to FIG. 6C) projecting in a direction along the axial line C1 toward the clutch member 32. Gear teeth are formed on an outer circumferential face of the engaging portion 34c.

### Action and Function of Clutch Member

The clutch member 32 is positioned rather close to the operation dial 34 when it is at the lock position (FIG. 6C). At this time, the engaging portion 34c of the operation dial 34 is fitted with an inner side of the internal gear portion 32a of the clutch member 32 and is held in engagement with the internal gear portion 32a. In particular, the internal gear portion 32a of the clutch member 32 is held in engagement with the engaging portion 34c such that the clutch member 32 rotates together with the operation dial 34. Accordingly, the clutch member 32 is held in engagement with both the link member 31 and the operation dial 34.

On the other hand, when the clutch member 32 is at the unlock position (FIGS. 7 and 8B), it is positioned rather close to the link member 31. At this time, the gear portion 32a of the clutch member 32 is spaced away from the engaging portion 34c of the operation dial 34. In particular, although the clutch member 32 is in engagement with the supporting portion 31b of the link member 31, it is not in engagement with the operation dial 34.

In this manner, when the clutch member 32 is at the lock position, it engages with both the link member 31 and the operation dial 34. Therefore, the link member 31 and the operation dial 34 are connected to each other through the clutch member 32. On the other hand, when the clutch member 32 is at the unlock position, it does not engage with the operation dial 34. Therefore, the connection between the link member 31 and the operation dial 34 is cancelled.

The positional relation and the engagement relation of the link member 31, the operation dial 34, and the clutch member 32 are not restricted to those in the example described above. For example, a supporting portion may be formed on the clutch member 32 in place of the supporting portion 31b of the link member 31. The supporting portion of the clutch member 32 may fit with an inner side of the link member 31 and engage with the link member 31. Alternatively, a supporting portion may be formed on the operation dial 34 in place of the supporting portion 31b of the link member 31. Then, the clutch member 32 may engage with the supporting portion of the operation dial 34. In this case, the clutch member 32 may be configured such that, when it is at the unlock position, it engages with the operation dial 34 but does not engage with the link member 31.

The clutch member 32 is biased toward the lock position. In the example depicted, the adjustment mechanism M includes a spring 37 that biases the clutch member 32 from the unlock position (FIGS. 7 and 8B) toward the lock position (FIG. 6C). The spring 37 is, for example, a coil spring and is fitted around the outer side of the supporting portion 31b of the link member 31. As depicted in FIG. 6B, the spring 37 is arranged between the wall portion 36c of the holder 36 and the wall portion 31c of the clutch member 32 and pushes the clutch member 32 toward the operation dial 34, that is, toward the lock position. The clutch member 32 may have an annular recessed portion 32b (refer to FIG. 6C) formed therein such that the spring 37 is fitted therein. This can reduce the size of the movable portion 30 (adjustment mechanism M) in the forward and rearward direction.

The operation button 39 is supported in such a manner as to move in a direction along the axial line C1. The operation button 39 is a button for allowing the user to move the clutch member 32 from the lock position (FIG. 6C) toward the unlock position (FIGS. 7 and 8B). As depicted in FIG. 7, when the operation button 39 is pushed by the user, this moves the clutch member 32, which is at the lock position (FIG. 6C), to the unlock position against the force of the spring 37. In FIG. 7, the clutch member 32 is pushed to move by the operation button 39, and the gear portion 32a of the clutch member 32 is spaced away from the engaging portion 34c of the operation dial 34.

The operation button 39 is supported by the operation dial 34. The operation button 39 has pushing portions 39a projecting in a direction along the axial line C1. The pushing portions 39a (refer to FIG. 5A) extend through holes formed in the operation dial 34 and can push the clutch member 32.

### Clutch Stopper

The clutch stoppers 35A and 35B are movable between a clutch stopper working position (FIGS. 8A and 8B) and a clutch stopper cancellation position (FIGS. 6A and 6C). The clutch stoppers 35A and 35B are supported by the operation dial 34 such that they can move between the two positions. Further, the clutch stoppers 35A and 35B rotate around the axial line C1 together with the operation dial 34.

For example, the clutch stoppers 35A and 35B each have a supported portion 35b as depicted in FIG. 8A. The supported portion 35b is supported by a support shaft (protrusion projecting in a direction along the axial line C1) formed on the operation dial 34. The clutch stoppers 35A and 35B can move between the clutch stopper working position and the clutch stopper cancellation position around the support shaft. In the example depicted, the two clutch stoppers 35A and 35B are arranged on opposite sides to each other across the axial line C1. The number of clutch stoppers 35A and 35B is not restricted to two and may be one or more than two.

The clutch stoppers 35A and 35B each have a stopper portion 35a (refer to FIG. 8A). As depicted in FIG. 8B, when the clutch stoppers 35A and 35B are at the clutch stopper working position, the stopper portion 35a abuts against a side face of the clutch member 32 (face facing the operation dial 34) to prevent the clutch member 32 from returning to the lock position by the elastic force of the spring 37. On the other hand, when the clutch stoppers 35A and 35B are at the clutch stopper cancellation position, the stopper portion 35a is spaced away from the side face of the clutch member 32 in a radial direction of the clutch member 32. Then, the clutch member 32 is permitted to return to the lock position by the elastic force of the spring 37.

As depicted in FIG. 8A, the clutch stoppers 35A and 35B are biased toward the clutch stopper working position by an elastic member. The clutch stopper 35A may be biased toward the clutch stopper working position, for example, by a spring 38 supported by the operation dial 34. A protrusion 35c may be formed at the stopper portion 35a of the clutch stopper 35A, and the protrusion 35c may be pushed by the spring 38.

The two clutch stoppers 35A and 35B may be interlocked. In the example depicted, the clutch stopper 35A has an engaging portion 35e (refer to FIG. 8A) at a base portion thereof, and the clutch stopper 35B has an engaged portion 35f (refer to FIG. 8A) at a base portion thereof. The engaging portion 35e and the engaged portion 35f are engaged with each other such that the two clutch stoppers 35A and 35B are interlocked. In particular, if the clutch stopper 35A is moved to the clutch stopper working position (FIG. 8A) by the elastic force of the spring 38, then the engaging portion 35e pushes the engaged portion 35f to move also the other clutch stopper 35B to the clutch stopper working position (FIG. 8A). Conversely, if the clutch stopper 35B is moved to the clutch stopper cancellation position (FIG. 6A), the engaged portion 35f pushes the engaging portion 35e to also move the clutch stopper 35A to the clutch stopper cancellation position (FIG. 6A). With this structure, the number of elastic members (spring 38) can be reduced.

When the clutch member 32 is pushed by the operation button 39 to move from the lock position (FIG. 6C) to the unlock position (FIGS. 7 and 8B), the clutch stoppers 35A and 35B are positioned at the clutch stopper working position (FIGS. 8A and 8B) by the elastic force of the spring 38. As a result, the stopper portion 35a prevents the clutch member 32, which is acted upon by the elastic force of the spring 37, from returning to the lock position (FIG. 6C).

### Action and Function of Clutch Stopper

As depicted in FIG. 8A, the gear portion 36a described hereinabove is formed on the holder 36 in which the spiral spring 26 is accommodated. In the example depicted, the gear portion 36a is an internal gear. The clutch stoppers 35A and 35B are arranged on an inner side of the gear portion 36a. An engaging portion 35g is formed on the clutch stopper 35B. The engaging portion 35g is a protrusion projecting in the radial direction and is fitted, when the clutch stoppers 35A and 35B are at the clutch stopper working position, between two teeth adjacent to each other of the gear portion 36a as depicted in FIG. 8A.

The clutch stoppers 35A and 35B are supported by the support shafts (protrusions) formed on the operation dial 34. Therefore, if the user rotates the operation dial 34, the clutch stoppers 35A and 35B rotate relative to the gear portion 36a of the holder 36 together with the operation dial 34. Then, the engaging portion 35g of the clutch stopper 35B is pushed to the inner side by the teeth of the gear portion 36a as depicted in FIG. 6A. As a result, the clutch stopper 35B moves from the clutch stopper working position (FIG. 8A) to the clutch stopper cancellation position (FIG. 6A), and a movement of the clutch member 32 toward the lock position (refer to FIG. 6B) is permitted.

In the example depicted, the two clutch stoppers 35A and 35B are interlocked. Therefore, if the clutch stopper 35B moves from the clutch stopper working position (FIG. 8A) to the clutch stopper cancellation position (FIG. 6A), then also the other clutch stopper 35A moves similarly. Consequently, the clutch member 32 moves to the lock position (FIG. 6C) and advances to a position between the stopper portions 35a of the two clutch stoppers 35A and 35B. The clutch stoppers 35A and 35B are prevented by the outer circumferential face of the clutch member 32 from returning to the clutch stopper working position (FIG. 8A) by the elastic force of the spring 38. In other words, since the clutch stoppers 35A and 35B abut against the outer circumferential face of the clutch member 32, they do not return to the clutch stopper working position (FIG. 8A).

As depicted in FIG. 7, if the user pushes the operation button 39, the clutch stoppers 35A and 35B that are at the stopper cancellation position move toward the stopper working position, whereupon the clutch member 32 moves to the unlock position. Simultaneously with this, the clutch stoppers 35A and 35B return to the clutch stopper working position (FIG. 8A) by the elastic force of the spring 38.

In this manner, the clutch stoppers 35A and 35B move from the clutch stopper working position (FIG. 8A) to the clutch stopper cancellation position (FIG. 6A) together with the rotation of the operation dial 34 in the reduction rotation direction. As a result, the clutch member 32 automatically moves to the lock position (FIG. 6B), so that the movement of the movable portion 30 in the direction in which the size of the mounting band 20 increases is restricted.

### Mounting Procedure of HMD on Head

The mounting band 20 including the adjustment mechanism M described above is used, for example, in the following manner. The user pushes the operation button 39 to place the movable portion 30 into the unlock state. Then, the user moves the movable portion 30 in the expansion direction or the reduction direction to roughly adjust the size of the mounting band 20 and then mounts the mounting band 20 on the own head of the user. At this time, the mounting band 20 is temporarily fixed to the head of the user by the force of the spiral spring 26. Thereafter, the user rotates the operation dial 34 in the reduction rotation direction. At the moment at which the operation dial 34 is rotated, the operation dial 34 and the link member 31 are connected to each other through the clutch member 32, thereby establishing a lock state of the mounting band 20. As a result, if the rotation of the operation dial 34 continues, the movable portion 30 moves in the reduction direction (that is, the length of the mounting band 20 decreases). Further, by an action of the dial stopper 33 that is in engagement with the operation dial 34, the movement of the movable portion 30 in the expansion direction is restricted. Therefore, also after the user stops the rotation of the operation dial 34, the movable portion 30 does not move in the expansion direction, and the length of the mounting band 20 is fixed.

In this manner, the movable portion 30 is configured such that it moves in the reduction direction together with a movement of the operation dial 34 in the reduction rotation direction, and the adjustment mechanism M switches the mounting band 20 from the unlock state to the lock state together with the movement of the operation dial 34 in the reduction rotation direction. Therefore, only by one operation of the user to move the operation dial 34 in the reduction rotation direction, the mounting band 20 can be placed into the lock state.

### Positional Relation of Parts and Members Configuring Adjustment Mechanism

In the following, a positional relation of the members configuring the adjustment mechanism M in a direction along the axial line C1 is described.

The operation dial 34 is positioned in the rear of the spiral spring 26. The operation dial 34 is exposed to the rear side from the opening formed in the housing 30a of the movable portion 30. In the example depicted, an outer circumferential face 34a of the operation dial 34 (refer to FIG. 6B) and a rear face 34b of the operation dial 34 (refer to FIG. 6B) are exposed from the housing 30a. According to this arrangement of the operation dial 34, even where the spiral spring 26 used has a great diameter, the user can access the operation dial 34 easily, so that operability of the operation dial 34 is ensured.

As described hereinabove, the adjustment mechanism M includes the ratchet mechanism that includes the dial stopper 33 (refer to FIG. 6A) and the gear portion 36a (refer to FIG. 6A) and that restricts the rotation direction of the operation dial 34 to the reduction rotation direction. Further, the adjustment mechanism M includes the clutch mechanism that performs switching between the state (lock state) in which the link member 31 and the operation dial 34 are interlocked and the state (unlock state) in which the link member 31 and the operation dial 34 are not interlocked. In the example described hereinabove, the clutch mechanism includes the clutch member 32 (refer to FIG. 6A), the clutch stoppers 35A and 35B (refer to FIG. 6A), and the gear portion 36a (refer to FIG. 6A). Both the ratchet mechanism and the clutch mechanism are arranged on the same side with respect to the spiral spring 26. In the example depicted, the two mechanisms are arranged on the rear side of the spiral spring 26 (side on which the operation dial 34 is arranged). More particularly, the two mechanisms are arranged on the rear side of the holder 36 holding the spiral spring 26. By this arrangement of the two mechanisms, the structure of the adjustment mechanism can be simplified. For example, elements can be used in a shared manner by the ratchet mechanism and the clutch mechanism.

In the example depicted, the gear portion 36a formed on the holder 36 is used in a shared manner by the two mechanisms. In particular, the engaging portion 33b of the dial stopper 33 and the engaging portion 35g of the clutch stopper 35B are held in engagement with the gear portion 36a. This can reduce the number of parts.

It is to be noted that, conversely to the example depicted, the supported portion 33a of the dial stopper 33 and the supported portions 35b of the clutch stoppers 35A and 35B may be supported by a support shaft formed on the holder 36. In this case, the gear portion 36a with which the dial stopper 33 and the clutch stoppers 35A and 35B engage may be formed on the operation dial 34. Alto in this case, the gear portion 36a is used in a shared manner by the two mechanisms, and reduction in the number of parts can be achieved.

As depicted in FIG. 6A, the three members, i.e., the dial stopper 33 and the clutch stoppers 35A and 35B, are arranged on the inner side of the gear portion 36a. The dial stopper 33 is arranged on a side opposite to the clutch stoppers 35A and 35B across the axial line C1. With this arrangement of the dial stopper 33, the clutch stoppers 35A and 35B, and the gear portion 36a, the size of the movable portion 30 (adjustment mechanism M) in the forward and rearward direction (direction along the axial line C1) can be reduced.

As depicted in FIG. 6C, a front edge 35h of the clutch stopper 35A is positioned in front of a rear edge 36e of the gear portion 36a. That is, when they are viewed in a direction orthogonal to the axial line C1, part of the clutch stopper 35A and part of the gear portion 36a overlap. This similarly applies to the clutch stopper 35B and the dial stopper 33. That is, when they are viewed in a direction orthogonal to the axial line C1, part of the clutch stopper 35B and part of the gear portion 36a overlap, and part of the dial stopper 33 and part of the gear portion 36a overlap. With this arrangement of the dial stopper 33, the clutch stoppers 35A and 35B, and the gear portion 36a, the size of the movable portion 30 (adjustment mechanism M) in the forward and rearward direction (direction along the axial line C1) can be reduced.

### Summary

As described above, in the HMD 1, the adjustment mechanism M includes the operation dial 34 that is operated by the user and the link member 31 held in engagement with the rear portion (rack 24a) of the right band portion 24R and the rear portion (rack 24a) of the left band portion 24L, and the link member 31 is moved in such a manner that the length of the mounting band 20 changes in response to a movement of the operation dial 34. The adjustment mechanism M includes the spiral spring 26 that applies elastic force to the link member 31. The spiral spring 26 is arranged such that the center line of the spiral spring 26 extends along the forward and rearward direction as viewed in top plan. With this HMD 1, while increase of the size of the adjustment mechanism M in the forward and rearward direction is suppressed, the spring 26 for adjusting the size of the mounting band 20 to the head of the user can be used.

Further, in the HMD 1, the adjustment mechanism M includes the ratchet mechanism that restricts the rotation direction of the operation dial 34 to one direction and the clutch mechanism that performs switching between the state in which the link member 31 is interlocked with the operation dial 34 and the state in which the link member 31 is not interlocked with the operation dial 34. Part of the ratchet mechanism and part of the clutch mechanism are used in a shared manner. More particularly, the gear portion 36a is used in a shared manner by the ratchet mechanism and the clutch mechanism. With this HMD 1, the number of parts can be reduced.

### Modifications

It is to be noted that the HMD proposed in the present disclosure is not restricted to the HMD 1 described above.

For example, the dial stopper 33 of the ratchet mechanism may be arranged on an outer side of the gear portion 36a, and the clutch stoppers 35A and 35B may be arranged on the inner side of the gear portion 36a. In this case, gear teeth with which the clutch stoppers 35A and 35B are to engage may be formed on the inner side of the gear portion 36a, and gear teeth with which the dial stopper 33 is to engage may be formed on the outer side of the gear portion 36a.

Further, in another example, the operation dial 34 and the link member 31 may not necessarily be arranged on the common axial line C1. For example, gear portions that are engageable with each other may be formed on an outer circumferential portion of the operation dial 34 and an outer circumferential portion of the link member 31. Further, the operation dial 34 and the link member 31 may be movable relative to each other in a radial direction of the gears between a position at which the gear portions engage with each other and another position at which the engagement of the gear portions is cancelled. Further, the rotation direction of the operation dial 34 may be restricted to one direction. Also with such a structure, by causing the gear portion of the operation dial 34 and the gear portion of the link member 31 to engage with each other, the lock state of the mounting band 20 can be implemented.

In a further example, the adjustment mechanism M may not include the clutch member 32. In this case, the adjustment mechanism M may connect (engage) the operation dial 34 and the link member 31 to (with) each other or may cancel the connection between them, by moving the operation dial 34 or the link member 31 in its axial direction.

In a still further example, the adjustment mechanism M may not include the operation dial 34. In this case, the user can directly move the movable portion 30 in the reduction direction or the expansion direction. Further, the adjustment mechanism M may cause the link member 31 to transition from a state in which rotation in both the reduction rotation direction and the expansion rotation direction is possible to another state in which only rotation in the reduction rotation direction is permitted and rotation in the expansion rotation direction is restricted. Such a structure can be implemented, for example, by moving a stopper for restricting the rotation direction of the link member 31 relative to the link member 31.

In a yet further example, the operation member (operation dial 34 in the HMD 1) may not necessarily be a rotation member. For example, the operation member may be a slide member that is movable in a radial direction of the link member 31 between a position at which it engages with the link member 31 and another position at which it does not engage with the link member 31.

### REFERENCE SIGNS LIST

1: Head-mounted display (HMD)
10: Main body
11: Display unit
14: Housing
20: Mounting band
23: Connection portion
24L: Left band portion
24R: Right band portion
24a: Rack
26: Spiral spring
26a: End portion
26b: End portion
30: Movable portion
30a: Housing
30b: Cushion
31: Link member
31a: Pinion
31b: Supporting portion
31c: Wall portion
31d: Protrusion
32: Clutch member
32a: Gear portion
32b: Recessed portion
33: Dial stopper
33a: Supported portion
33b: Engaging portion
34: Operation dial
34a: Outer circumferential face
34b: Rear face
34c: Engaging portion
35A, 35B: Clutch stopper
35a: Stopper portion
35b: Supported portion
35c: Protrusion
35e: Engaging portion
35f: Engaged portion
35g: Engaging portion
35h: Front edge
36: Holder
36a: Gear portion
36b: Engaged portion
36c: Wall portion
36d: Outer circumferential wall
36e: Rear edge
37: Spring
38: Spring
39: Operation button
39a: Pushing portion
M: Adjustment mechanism

1. A head-mounted display comprising:
a main body including a display unit; and
a mounting band that supports the main body;
the mounting band including
a right band portion that is a right portion of the mounting band,
a left band portion that is a left portion of the mounting band, and
an adjustment mechanism that includes an operation member operated by a user and a link member held in engagement with a rear portion of the right band portion and a rear portion of the left band portion, the adjustment mechanism moving the link member in such a manner that a length of the mounting band changes in response to a movement of the operation member;
the adjustment mechanism including a spiral spring that applies elastic force to the link member; and
the spiral spring being arranged in such a manner as to have its center line extending along a forward and rearward direction as viewed in top plan.

2. The head-mounted display according to claim 1, wherein
the rear portion of the right band portion and the rear portion of the left band portion are spaced from each other in an upward and downward direction,
the link member is arranged between the rear portion of the right band portion and the rear portion of the left band portion, and
the spiral spring is arranged side by side with the link member in the forward and rearward direction.

3. The head-mounted display according to claim 1, wherein the spiral spring is arranged on a rear side of the rear portion of the right band portion and the rear portion of the left band portion.

4. The head-mounted display according to claim 2, wherein the spiral spring has a diameter greater than a width of the rear portion of the right band portion and the rear portion of the left band portion in the upward and downward direction.

5. The head-mounted display according to claim 1, wherein
the operation member is a rotatable member,
the adjustment mechanism includes a ratchet mechanism that defines a rotation direction of the operation member to one direction and a clutch mechanism that performs switching between a state in which the link member is interlocked with the operation member and another state in which the link member is not interlocked with the operation member, and
at least part of the ratchet mechanism and at least part of the clutch mechanism are arranged on a same side with respect to the spiral spring.

6. The head-mounted display according to claim 5, wherein the at least part of the ratchet mechanism, the at least part of the clutch mechanism, and the operation member are arranged on a rear side of the spiral spring.

7. The head-mounted display according to claim 1, wherein
the operation member is a rotatable member,
the adjustment mechanism includes a ratchet mechanism that defines a rotation direction of the operation member to one direction and a clutch mechanism that performs switching between a state in which the link member is interlocked with the operation member and another state in which the link member is not interlocked with the operation member, and
part of the ratchet mechanism and part of the clutch mechanism are used in a shared manner.

8. The head-mounted display according to claim 1, wherein
the operation member is a rotatable member,
a holder in which the spiral spring is accommodated is provided,
the adjustment mechanism includes a ratchet mechanism that defines a rotation direction of the operation member to one direction, and
part of the ratchet mechanism is formed on the holder.

9. The head-mounted display according to claim 1, wherein
the operation member is a rotatable member,
a holder in which the spiral spring is accommodated is provided,
the adjustment mechanism includes a clutch mechanism that performs switching between a state in which the link member is interlocked with the operation member and another state in which the link member is not interlocked with the operation member, and
part of the clutch mechanism is formed on the holder.

10. A head-mounted display comprising:
a main body including a display unit; and
a mounting band that supports the main body;
the mounting band including
a right band portion that is a right portion of the mounting band,
a left band portion that is a left portion of the mounting band, and
an adjustment mechanism that includes an operation member operated by a user and a link member held in engagement with a rear portion of the right band portion and a rear portion of the left band portion, the adjustment mechanism moving the link member in such a manner that a length of the mounting band changes in response to a movement of the operation member;
the operation member being a rotatable member;
the adjustment mechanism including a ratchet mechanism that defines a rotation direction of the operation member to one direction and a clutch mechanism that performs switching between a state in which the link member is interlocked with the operation member and another state in which the link member is not interlocked with the operation member; and
part of the ratchet mechanism and part of the clutch mechanism being used in a shared manner.
